(19) United States
(12) Patent Application Publication
(10) Pub. No.: US 2026/0159432 A1
(43) Pub. Date: Jun. 11, 2026

(54) FILLING STRUCTURES AND FILLING METHODS FOR REDUCING NEEDLE DEFECTS IN SUBSTRATE GLASS

(71) Applicant: CAIHONG DISPLAY DEVICES CO., LTD., Xianyang (CN)

(72) Inventors: Menglong WANG, Xianyang (CN); Hongrong HOU, Xianyang (CN); Wei YANG, Xianyang (CN); Tao ZHANG, Xianyang (CN)

(73) Assignee: CAIHONG DISPLAY DEVICES CO., LTD., Xianyang (CN)

(21) Appl. No.: 19/405,348

(22) Filed: Dec. 1, 2025

Related U.S. Application Data
(63) Continuation of application No. PCT/CN2025/113685, filed on Aug. 8, 2025.

(30) Foreign Application Priority Data
Dec. 5, 2024 (CN) 202411781166.1

(51) Int. Cl. C03B 5/43; C03B 3/00

(52) U.S. Cl. CPC C03B 5/43; C03B 3/00

(57) ABSTRACT

A filling structure and a filling method for reducing needle defects in substrate glass are provided. The filling structure includes: a platinum body, a flange, and a main section refractory structure. The flange is sleeved on the platinum body. The main section refractory structure is disposed outside the platinum body. One or more filler layers are disposed in a cavity formed between the main section refractory structure and an outer wall of the platinum body. The filler layers form a concentric-ring structure or a segmented structure. The concentric-ring structure includes inner and outer rings. The segmented structure includes first, second, and third filler layers arranged from top to bottom. The filling method is implemented through the filling structure such that a channel temperature T_{b} of the platinum body and a temperature T_{f} of the flange platinum disk satisfy: T_{b}-T_{f}≤210° C., and T_{b}≥1380° C.

### CROSS-REFERENCE TO RELATED APPLICATIONS

This application is a Continuation of International Patent Application No. PCT/CN 2025/113685, filed on Aug. 8, 2025, which claims priority to Chinese Patent Application No. 202411781166.1, filed on Dec. 5, 2024, the entire contents of each of which are hereby incorporated by reference.

### TECHNICAL FIELD

The present disclosure generally relates to a field of defect prevention and control in substrate glass, and in particular to a filling structure and a filling method for reducing needle defects in substrate glass.

### BACKGROUND

Needle defects, as a major flaw in a manufacturing process of substrate glass, are primarily composed of platinum (Pt) or a mixture of platinum and rhodium (Rh). These defects are elongated and needle-like in shape. The length of a needle defect typically ranges from 30 micrometers to 600 micrometers, and its cross-sectional equivalent diameter ranges from 0.5 micrometers to 10 micrometers. The overall size is minuscule, requiring an optical microscope for observation. The distribution of these defects within the glass is not fixed but is random throughout the plate thickness, and is often generated with fluctuations in a liquid level or temperature variations in a flange of the clarification section. Research indicates that a formation of the needle defects is closely related to a temperature difference between the inside and outside of a channel, especially local cold spots in high-temperature regions. Once a suitable growth interface is available, Pt and Rh elements dissolved in a glass melt will precipitate and crystallize upon reaching a saturation state. These crystals may be released in large quantities due to long-term slow detachment or significant disturbances during the process.

Currently, the field of substrate glass production still faces numerous challenges in addressing needle defects. Traditional filling techniques have limitations in controlling the temperature of the region of the flange platinum disk. The difference in thermal insulation efficacy between cold-state and hot-state filling is difficult to eliminate, resulting in a persistent inability to effectively control the temperature difference between the inside and outside of the platinum tube. Although some companies have attempted to improve thermal insulation by enhancing filling materials or optimizing the filling process, the effectiveness is not significant due to constraints of actual production conditions. Most existing technologies focus on adjusting the production process at a macro level, lacking an in-depth understanding of the microscopic mechanism of crystallization and effective control methods for the specific process. Furthermore, no reliable prevention or treatment measures have been found for the problems of needle defect detachment and their entrainment into the liquid surface. This results in the persistent presence of needle defects during the production process, severely impacting the quality of the substrate glass and production efficiency.

Therefore, there is an urgent need to develop a filling structure and a filling method for reducing needle defects in substrate glass. Such a development should enhance the thermal insulation and sealing effectiveness of the filling technique, thereby controlling needle defects during the substrate glass production process and improving product quality and production efficiency.

### SUMMARY

One or more embodiments of the present disclosure provides a filling structure for reducing needle defects in substrate glass. The filling structure includes: a platinum body, a flange, and a main section refractory structure. The flange is sleeved on the platinum body. The main section refractory structure is disposed outside the platinum body. One or more filler layers are disposed in a cavity formed between the main section refractory structure and an outer wall of the platinum body. The one or more filler layers form a concentric-ring structure or a segmented structure. The concentric-ring structure includes an inner ring and an outer ring. A partition device is disposed at a junction between the inner ring and the outer ring. A filler layer of the inner ring is a cavity portion between the outer wall of the platinum body and an outer wall of a flange platinum disk. A filler layer of the outer ring is a cavity portion between the outer wall of the flange platinum disk and the main section refractory structure. The segmented structure includes a first filler layer, a second filler layer, and a third filler layer arranged from top to bottom. The first filler layer is a cavity portion between a first horizontal cross-section of the flange platinum disk and the main section refractory structure above the flange platinum disk. The third filler layer is a cavity portion between a second horizontal cross-section of the flange platinum disk and the main section refractory structure below the flange platinum disk. The second filler layer is a cavity portion between the first horizontal cross-section of the flange platinum disk and the second horizontal cross-section of the flange platinum disk. The first horizontal cross-section of the flange platinum disk is disposed 80-150 mm above a top horizontal cross-section of the platinum body. The second horizontal cross-section of the flange platinum disk is disposed 80-150 mm below a bottom horizontal cross-section of the platinum body.

One or more embodiments of the present disclosure provides a filling method for reducing needle defects in substrate glass. The filling method includes: when the one or more filler layers form the concentric-ring structure, selecting a filling material for the outer ring and a filling material for the inner ring such that a channel temperature T_{b} of the platinum body in a region of the flange platinum disk and a temperature T_{f} of the flange platinum disk satisfy a following relationship: T_{b}-T_{f}≤210° C., and T_{b}≥1380° C.; using a soft ceramic fiber cloth as the partition device for the inner ring and the outer ring, placing the soft ceramic fiber cloth in advance inside the cavity formed between the main section refractory structure and the outer wall of the platinum body, and fixing two ends of the soft ceramic fiber cloth using a clamping device; and filling the outer ring and the inner ring, respectively. When filling of the inner ring is completed, removing the clamping device, splicing the two ends of the soft ceramic fiber cloth into one piece, and continuing to fill the outer ring until the filling is completed.

One or more embodiments of the present disclosure provides a filling method for reducing needle defects in substrate glass. The filling method includes: when the one or more filler layers form the concentric-ring structure, selecting a filling material for the outer ring and a filling material for the inner ring such that a channel temperature T_{b} of the platinum body in a region of the flange platinum disk and a temperature T_{f} of the flange platinum disk satisfy a following relationship: T_{b}-T_{f}≤210° C., and T_{b}≥1380° C.; using a hard brick structure as the partition device for the inner ring and the outer ring, wherein an upper portion of the hard brick structure has a spliced structure, a connection between a lower portion and the upper portion of the hard brick structure is a detachable structure, and placing the lower portion of the hard brick structure in advance inside the cavity formed between the main section refractory structure and the outer wall of the platinum body; and first completing filling of lower portions of the inner ring and the outer ring; then connecting the lower portion and the upper portion of the hard brick structure; continuing to fill the inner ring; when the filling of the inner ring is completed, splicing the upper portion of the hard brick structure into one piece; and continuing to fill the outer ring until filling is completed.

One or more embodiments of the present disclosure provides a filling method for reducing needle defects in substrate glass. The filling method includes: when the one or more filler layers form the segmented structure, selecting filling materials for the first filler layer, the second filler layer, and the third filler layer such that a channel temperature T_{b} of the platinum body in a region of the flange platinum disk and a temperature T_{f} of the flange platinum disk satisfy a following relationship: T_{b}-T_{f}≤210° C., and T_{b}≥1380° C.; filling the third filler layer, the second filler layer, and the first filler layer sequentially.

Compared with the prior art, the positive progressive effects of the embodiments of the present disclosure are as follows.

The filling structure provided by the embodiments of the present disclosure comprehensively considers the thermal insulation and heating characteristics of the filling material, fundamentally optimizing the environmental conditions for the crystallization reaction. By constructing a multi-layer thermal insulation filling structure, the crystallization phenomenon is effectively suppressed, thereby significantly reducing the generation of needle defects. By scientifically and rationally distributing the filler layers, a difference in thermal expansion between the platinum body and the surrounding refractory material is balanced, reducing a risk of structural damage caused by excessive thermal stress, and further ensuring the stability and safety of the production process.

Furthermore, the introduction of the heating elements enables fine control of the temperature in the platinum tube region, effectively reducing local temperature differences and further suppressing the crystallization phenomenon.

### BRIEF DESCRIPTION OF THE DRAWINGS

The drawings of the present disclosure are used to provide further understanding of the embodiments of the present disclosure, constitute a part of the embodiments of the present disclosure, and the illustrative embodiments of the present disclosure and the descriptions thereof are used to explain the embodiments of the present disclosure and do not constitute an undue limitation on the embodiments of the present disclosure.

FIG. 1 is a schematic diagram illustrating a structure of a needle defect according to some embodiments of the present disclosure;

FIG. 2 is a schematic diagram illustrating a formation principle of a needle defect according to some embodiments of the present disclosure;

FIG. 3 is a schematic diagram illustrating a radial cross-section of a filling structure according to some embodiments of the present disclosure;

FIG. 4 is a schematic diagram illustrating a radial cross-section of a segmented structure according to some embodiments of the present disclosure;

FIG. 5 is a schematic diagram illustrating a radial cross-section of a concentric-ring structure according to some embodiments of the present disclosure;

FIG. 6 is a schematic diagram illustrating a structure of a soft ceramic fiber cloth according to some embodiments of the present disclosure;

FIG. 7 is a schematic diagram illustrating a structure of a hard brick structure according to some embodiments of the present disclosure;

FIG. 8 is a schematic diagram illustrating installation positions of a plurality of heating elements according to some embodiments of the present disclosure;

FIG. 9 is a flowchart of an exemplary process for a filling method for reducing needle defects in substrate glass according to some embodiments of the present disclosure; and

FIG. 10 is a flowchart of an exemplary process for a filling method for reducing needle defects in substrate glass according to some other embodiments of the present disclosure.

In the figures: 1 denotes a platinum body; 1-1 denotes a top horizontal cross-section; 1-2 denotes a bottom horizontal cross-section; 2 denotes a needle defect; 3 denotes a filler layer; 3-1 denotes an inner ring; 3-2 denotes an outer ring; 3-3 denotes a first filler layer; 3-4 denotes a second filler layer; 3-5 denotes a third filler layer; 4 denotes a flange; 4-1 denotes a flange platinum disk; 4-2 denotes an outer wall of the flange platinum disk; 5 denotes a heating element; 6 denotes a main section refractory structure; D denotes a cross-sectional equivalent diameter; L denotes a length.

### DETAILED DESCRIPTION

To make the objectives, technical solutions, and advantages of the embodiments of the present disclosure clearer, the technical solutions in the embodiments of the present disclosure will be clearly and completely described below in conjunction with the accompanying drawings in the embodiments of the present disclosure. Obviously, the described embodiments are part of the embodiments of the present disclosure, but not all of them. Components of the embodiments of the present disclosure described and illustrated in the accompanying drawings herein can generally be arranged and designed in various different configurations.

Therefore, the following detailed description of the embodiments of the present disclosure provided in the accompanying drawings is not intended to limit the scope of the present disclosure, but merely represents selected embodiments of the present disclosure. Based on the embodiments in the present disclosure, all other embodiments obtained by those skilled in the art without making creative efforts shall fall within the protection scope of the present disclosure.

It should be noted that similar reference numerals and letters denote similar items in the following accompanying drawings. Therefore, once an item is defined in one drawing, it does not need to be further defined and explained in subsequent drawings.

In the description of the present disclosure, it should be noted that the terms “upper,” “lower,” “horizontal,” “inner,” or the like indicate positional or orientation relationships based on the accompanying drawings. These terms are used merely for the purpose of facilitating the description and simplifying the explanation, and are not intended to indicate or imply that the referenced devices or components must have a particular orientation or be constructed and operated in a particular orientation. Therefore, such terms should not be construed as limiting the present disclosure. Furthermore, the terms “first,” “second,” or the like are used for descriptive purposes only and should not be interpreted as indicating or implying relative importance.

Furthermore, unless otherwise explicitly stated or limited, the terms “disposed,” “mounted,” “connected,” and “coupled” are to be interpreted broadly. For example, the connection may be a fixed connection, a detachable connection, or an integral connection; it may be a mechanical connection or an electrical connection; it may be a direct connection or an indirect connection through an intermediate medium; it may also refer to communication between the internal portions of two components. Those skilled in the art may understand the specific meanings of the above terms in the context of the present disclosure based on the specific implementation.

The following further describes the embodiments of the present disclosure in detail with reference to the accompanying drawings and specific embodiments. The description is an explanation of the present disclosure, not a limitation.

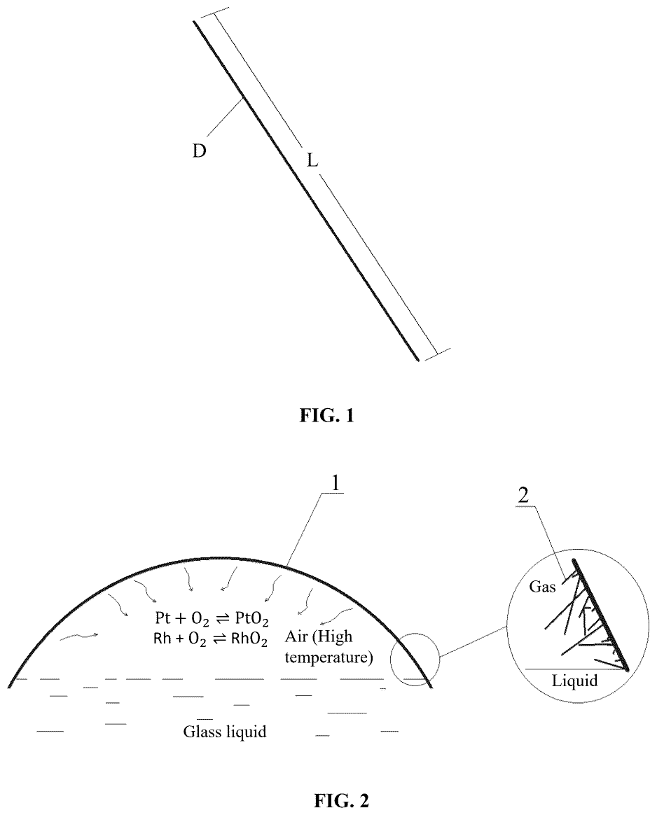

Before elaborating on the specific filling structure and filling method for reducing needle defects in substrate glass, the characteristics of needle defects in substrate glass are first explained. Referring to FIG. 1, a morphological feature of a needle defect in substrate glass is a defect with an extremely large ratio of a cross-sectional equivalent diameter to a length, which is a typical morphological feature of a crystal. A length L of the needle defect is generally at a micron level, typically satisfying: 30 μm<L<600 μm. After a cross-section of the needle defect is magnified more than 5000 times by an electron microscope, it may be observed that the needle defect mostly exhibits a polygonal or nearly circular structure, with an equivalent diameter D generally satisfying: 0.5 μm<D<10 μm. Element detection via scanning electron microscopy reveals that a main component of the needle defect is Pt element, and some defects also include a certain proportion of Rh element. A weight percentage of the Pt element satisfies: 70%<wt % content <100%. A weight percentage of the Rh element satisfies: 0%<wt % content<22%.

Based on the basic characteristics of needle defects and combined with high-temperature theory related to platinum and rhodium materials, a mechanism of the needle defects may be basically clarified. Specifically, from the perspective of high-temperature metal volatilization and saturated vapor pressure theory, in a high-temperature environment, a saturated vapor pressure of a substance increases as the temperature rises. For metal elements in a platinum body, such as Pt and Rh, under a high-temperature condition, vapor pressures of the metal elements also increase accordingly. When an actual vapor pressure in the environment is lower than a saturated vapor pressure of the metal element at a specific temperature, the metal will continuously volatilize. Furthermore, due to differences in physical and chemical properties of different metal elements, the different metal elements have different saturated vapor pressures at the same temperature, leading to differences in the volatilization temperatures and rates of Pt and Rh. A platinum channel oxidizes in the high-temperature environment, causing the base material to continuously volatilize. Particularly in the interior of the platinum channel corresponding to a flange root region, the temperature gradient is larger compared to other main sections. Locally, due to a lower temperature, tiny needle defects may saturate and precipitate, adhering to an inner wall of a tube body and continuously accumulating. A basic principle is shown in FIG. 2. When an internal airflow is disturbed or a liquid level fluctuates abnormally, these crystals fall into a glass liquid below, thereby forming defects in a substrate glass product. Furthermore, these defects show no clustering characteristics in a distribution along a thickness direction and a width direction of the glass substrate. In summary, the formation of needle defects involves a plurality of factors, including high-temperature oxidation of the platinum channel, material volatilization, temperature gradients, crystal precipitation, and internal airflow and liquid level fluctuations. Among these factors, the most critical distinction lies in the exceptionally significant temperature difference between the inside and outside of the defect formation region. Specifically, a difference between a channel temperature T_{b} of the platinum body in a region of the flange platinum disk and s temperature T_{f} of the flange platinum disk must be strictly controlled within a range of T_{b}-T_{f}≤210° C. This is a key control indicator derived from a series of high-temperature crystallization tests and comparative analysis of multi-line production processes. It has considerable reference value and can effectively prevent a precipitation of needle defects.

Referring to FIG. 3, the prior art uses a hot, one-time filling for this region. A filler layer selects zirconium-based powder, and the entire region, encompassing the platinum body, the flange platinum disk, and the flange connection row within refractory materials, is filled with the zirconium-based material. Although this approach satisfies a requirement that the channel temperature T_{b} of the platinum body in the region of the flange platinum disk is ≥1380° C., a thermal conductivity of this material is about 2.5 W/(m·° C.), making a thermal insulation efficacy of the material relatively unsatisfactory.

Therefore, the embodiments of the present disclosure not only emphasize high-temperature resistance in material selection but also focus on improving the thermal insulation efficacy, proposing segmented and concentric-ring filling strategies.

FIG. 3 is a schematic diagram illustrating a radial cross-section of a filling structure according to some embodiments of the present disclosure.

In some embodiments, as shown in FIG. 3, the filling structure for reducing needle defects in substrate glass may include a platinum body 1, a flange 4, and a main section refractory structure 6. The flange 4 is sleeved on the platinum body 1. The main section refractory structure 6 is disposed outside the platinum body 1. One or more filler layers are disposed in a cavity formed between the main section refractory structure 6 and an outer wall of the platinum body 1.

The platinum body 1 refers to a pipeline through which a glass liquid may flow. The platinum body 1 may be a tubular structure. In some embodiments, the platinum body 1 may be a platinum-rhodium alloy pipeline.

The flange 4 may be configured to fix the platinum body 1 to other structures (e.g., the main section refractory structure 6). For example, the flange 4 may enable the platinum body 1 to be suspended at a center of the main section refractory structure 6.

In some embodiments, the flange 4 may include a flange platinum disk 4-1. The flange platinum disk 4-1 may be an annular metal disk-shaped structure at a connection between the flange 4 and the platinum body 1.

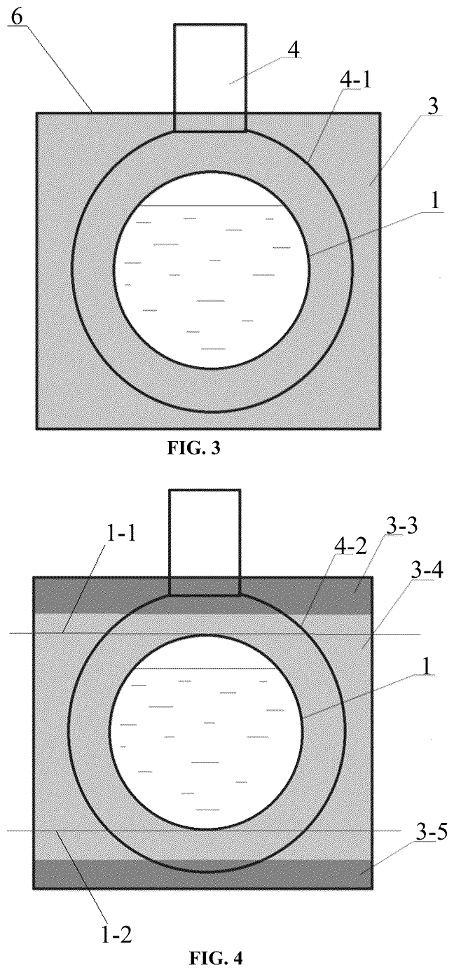

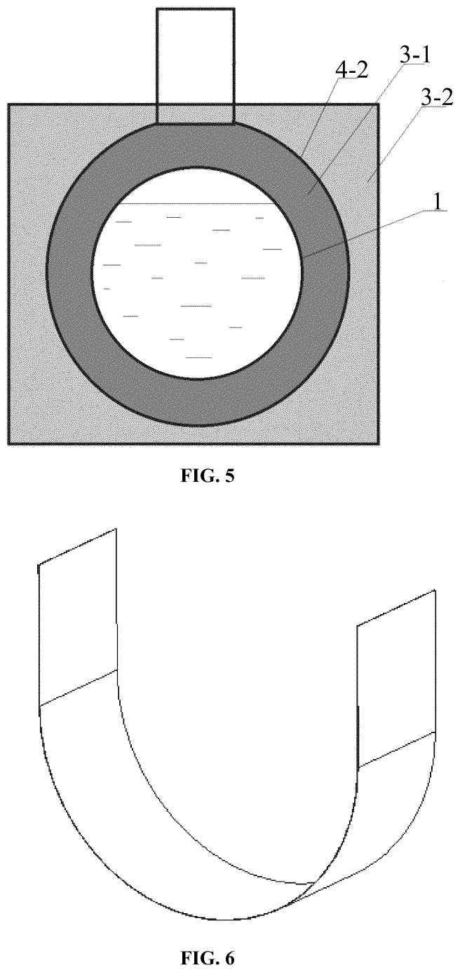

With reference to FIG. 3 and FIG. 4, the flange platinum disk 4-1 may include an inner wall (not shown in the figure) of the flange platinum disk and an outer wall 4-2 of the flange platinum disk. The inner wall of the flange platinum disk is a surface of an inner ring of the annular metal disk-shaped structure. The outer wall 4-2 of the flange platinum disk is a surface of an outer ring of the annular metal disk-shaped structure.

In some embodiments, the flange 4 may be sleeved on the platinum body 1. For example, the inner wall of the flange platinum disk 4-1 of the flange 4 may be sleeved on the outer wall of the platinum body 1 and welded for sealing. As another example, the flange platinum disk 4-1 may be sleeved outside the platinum body 1 and fixed by a mechanical connection.

The main section refractory structure 6 refers to a refractory material structure disposed outside the platinum body 1.

The main section refractory structure 6 may be a multi-layer structure. For example, the main section refractory structure 6 may be a cylinder formed by combining a heavy refractory layer, a light insulation layer, and an outer steel housing.

A cavity exists between the main section refractory structure 6 and the platinum body 1.

For example, a top end of the flange 4 may pass through the main section refractory structure 6, and the platinum body 1 may be pressed against a top of the main section refractory structure 6 by bolts.

The filler layer 3 refers to a cavity space to be filled with a filling material.

In some embodiments, one or more filler layers 3 may be disposed in a cavity formed between the main section refractory structure 6 and the outer wall of the platinum body 1. For example, the one or more filler layers 3 may be disposed in all cavities between the main section refractory structure 6 and the outer wall of the platinum body 1, except for the cavity occupied by the flange 4.

In some embodiments, the one or more filler layers 3 may form a concentric-ring structure or a segmented structure.

FIG. 5 is a schematic diagram illustrating a radial cross-section of a concentric-ring structure according to some embodiments of the present disclosure. As shown in FIG. 5, the concentric-ring structure refers to a concentric circle structure in which the one or more filler layers 3 are divided into an inner ring 3-1 and an outer ring 3-2 in a radial (horizontal) direction, using the outer wall 4-2 of the flange platinum disk of the flange 4 as a boundary.

In some embodiments, as shown in FIG. 5, the concentric-ring structure includes the inner ring 3-1 and the outer ring 3-2. A partition device may be disposed at a junction between the inner ring 3-1 and the outer ring 3-2. A filler layer 3 of the inner ring 3-1 may be a cavity portion between the outer wall of the platinum body 1 and the outer wall 4-2 of the flange platinum disk. A filler layer 3 of the outer ring 3-2 may be a cavity portion between the outer wall 4-2 of the flange platinum disk and the main section refractory structure 6.

The inner ring 3-1 may be a ring layer between the partition device and the platinum body 1.

The outer ring 3-2 may be a ring layer between the partition device and the main section refractory structure 6.

It should be understood that the partition device may be sleeved on an outside of the flange 4 along the outer wall 4-2 of the flange platinum disk. In this case, the cavity portion from the partition device to the outer wall of the platinum body 1 is the cavity portion between the outer wall of the platinum body 1 and the outer wall 4-2 of the flange platinum disk, i.e., the filler layer 3 of the inner ring 3-1. The cavity portion from the partition device to the main section refractory structure 6 is the cavity portion between the outer wall 4-2 of the flange platinum disk and the main section refractory structure 6, i.e., the filler layer 3 of the outer ring 3-2.

The partition device is a device configured to partition the cavity between the platinum body 1 and the main section refractory structure 6.

In some embodiments, the partition device may be one of a soft ceramic fiber cloth and a hard brick structure.

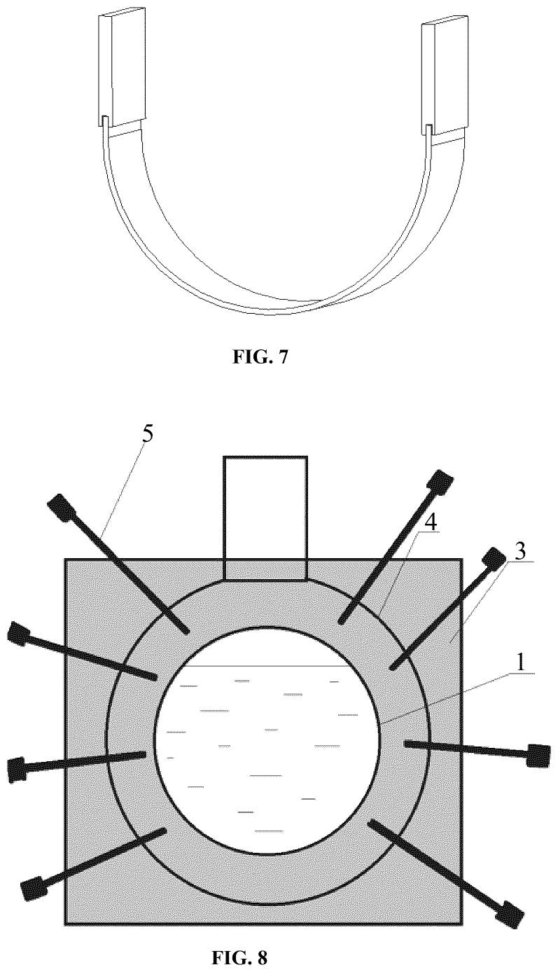

For example, the partition device may adopt a high-temperature resistant soft ceramic fiber cloth as shown in FIG. 6. Two ends of the soft ceramic fiber cloth are splicing ends.

As another example, the partition device may adopt a hard brick structure as shown in FIG. 7. A material of the hard brick structure is a zirconium-based material. An upper portion of the hard brick structure has a spliced structure. A connection between a lower portion and the upper portion of the hard brick structure is a detachable structure. The spliced structure may include a pin structure, a stepped engagement structure, etc. The detachable structure may include a tenon-and-mortise sliding chute, a slot, a spring buckle, etc.

Referring to FIG. 6, if the partition device adopts the high-temperature resistant soft ceramic fiber cloth, the soft ceramic fiber cloth may be placed in the filler layer 3 in advance. Two ends of the soft ceramic fiber cloth may be fixed by a temporary clamping device to support the soft ceramic fiber cloth to form a natural near-semicircular structure. During filling, zirconium powder may be filled in the inner ring 3-1, and alumina hollow sphere powder is filled in the outer ring 3-2. Finally, the entire soft ceramic fiber cloth is buried in the filling space to form an approximate circular structure in a core region. The clamping device refers to a structural component configured to fix the soft ceramic fiber cloth. For example, the clamping device may be a spring steel sheet, a vacuum suction cup, etc.

It should be understood that, referring to FIG. 7, if the partition device adopts the hard brick structure, the hard brick structure may be processed into an upper portion and a lower portion for detachable splicing. The lower portion has a semi-circular structure. The upper portion has a detachable arc plate structure. A material of the hard brick structure is a zirconium-based material commonly used in this region. During actual filling, filling is performed twice for the upper and lower portions.

It should be noted that when the hard brick structure or the soft ceramic fiber cloth is used as the partition device, a temperature T_{b} of a connection region of a channel of the platinum body 1 with the flange platinum disk 4-1 reaches 1401° C. An actual temperature difference between the temperature T_{b} in this region and a temperature T_{f} of the flange platinum disk 4-1 is 199° C., which meets design expectations. A quantity and a size of such defects in the product are also reduced by nearly 70%, showing a significant effect.

FIG. 4 is a schematic diagram illustrating a radial cross-section of a segmented structure according to some embodiments of the present disclosure. As shown in FIG. 4, a first horizontal cross-section and a second horizontal cross-section are set based on a top horizontal cross-section 1-1 and a bottom horizontal cross-section 1-2 of the platinum body 1. The one or more filler layers 3 are divided radially into a segmented structure including a first filler layer 3-3, a second filler layer 3-4, and a third filler layer 3-5.

In some embodiments, the segmented structure includes the first filler layer 3-3, the second filler layer 3-4, and the third filler layer 3-5 arranged from top to bottom.

In some embodiments, the first filler layer 3-3 is a cavity portion between the first horizontal cross-section of the flange platinum disk 4-1 and the main section refractory structure 6 above the flange platinum disk 4-1.

In some embodiments, the first horizontal cross-section refers to a plane for separating the first filler layer 3-3 and the second filler layer 3-4. In some embodiments, the first horizontal cross-section may be preset by a technician based on experience and does not have a physical structure.

In some embodiments, the first horizontal cross-section of the flange platinum disk 4-1 may be disposed 80-150 mm above the top horizontal cross-section 1-1 of the platinum body 1. The top horizontal cross-section 1-1 refers to a horizontal cross-section at the top of the platinum body 1.

In some embodiments, a distance between the first horizontal cross-section of the flange platinum disk 4-1 and the top horizontal cross-section 1-1 of the platinum body 1 may also be in a range of 80-87 mm, 87-94 mm, 94-101 mm, 101-108 mm, 108-115 mm, 115-122 mm, 122-129 mm, 129-136 mm, 136-143 mm, or 143-150 mm. In some embodiments, the distance between the first horizontal cross-section of the flange platinum disk 4-1 and the top horizontal cross-section 1-1 of the platinum body 1 may also be one of 80 mm, 87 mm, 94 mm, 101 mm, 108 mm, 115 mm, 122 mm, 129 mm, 136 mm, 143 mm, 150 mm, etc.

In some embodiments, the second filler layer may be a cavity portion between the first horizontal cross-section of the flange platinum disk 4-1 and the second horizontal cross-section of the flange platinum disk 4-1.

In some embodiments, the second horizontal cross-section of the flange platinum disk 4-1 may be disposed 80-150 mm below the bottom horizontal cross-section 1-2 of the platinum body 1. The bottom horizontal cross-section 1-2 refers to a horizontal cross-section at a bottom of the platinum body 1.

In some embodiments, a distance between the second horizontal cross-section of the flange platinum disk 4-1 and the bottom horizontal cross-section 1-2 of the platinum body 1 may also be in a range of 80-87 mm, 87-94 mm, 94-101 mm, 101-108 mm, 108-115 mm, 115-122 mm, 122-129 mm, 129-136 mm, 136-143 mm, or 143-150 mm. In some embodiments, the distance between the second horizontal cross-section of the flange platinum disk 4-1 and the bottom horizontal cross-section 1-2 of the platinum body 1 may also be one of 80 mm, 87 mm, 94 mm, 101 mm, 108 mm, 115 mm, 122 mm, 129 mm, 136 mm, 143 mm, 150 mm, etc.

For example, as shown in FIG. 4, an inner circle diameter of the flange platinum disk 4-1 may be 300 mm, and an outer circle diameter of the flange platinum disk 4-1 may be 500 mm. In the inner ring 3-1 with a thickness of 100 mm from the platinum body 1, zirconium powder is used for filling, i.e., the first horizontal cross-section of the flange platinum disk 4-1 is disposed 100 mm above the top horizontal cross-section 1-1 of the platinum body 1. The second horizontal cross-section of the flange platinum disk 4-1 is disposed 100 mm below the bottom horizontal cross-section 1-2 of the platinum body 1.

In some embodiments, the third filler layer 3-5 may be a cavity portion between the second horizontal cross-section of the flange platinum disk 4-1 and the main section refractory structure 6 below the flange platinum disk 4-1.

FIG. 8 is a schematic diagram illustrating installation positions of a plurality of heating elements according to some embodiments of the present disclosure.

In some embodiments, the filling structure for reducing needle defects in substrate glass further includes a plurality of heating elements 5. The heating elements 5 are disposed on the flange platinum disk 4-1 and are configured to heat the outer wall of the platinum body 1.

The heating element 5 refers to a component configured to heat the outer wall of the platinum body 1. For example, the heating element may be a heating rod. A material of the heating rod may be one of a silicon molybdenum rod and a platinum rod. A structural form of the heating rod is one of annular, sheet, and filament.

In some embodiments, the plurality of heating elements 5 may be arranged in a plurality of groups in a circumferential direction of the platinum body 1. For example, the heating elements 5 may be uniformly distributed around an outer side of a cross-section of the platinum body 1.

In some embodiments, a distance between an end of a heating element 5 and the platinum body 1 may be in a range of 10 mm-20 mm.

It should be understood that, referring to FIG. 8, by adding a plurality of groups of heating elements 5 on the flange platinum disk 4-1, direct heating of an exterior of the platinum body 1 is achieved, thereby increasing the channel temperature T_{b} of the platinum body 1 in the region of the flange platinum disk 4-1 and a temperature of its external region.

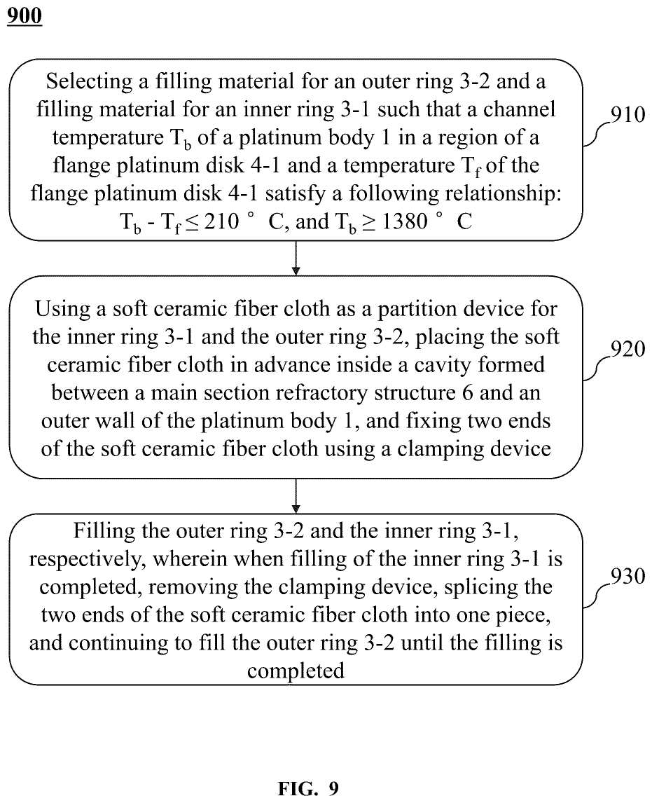

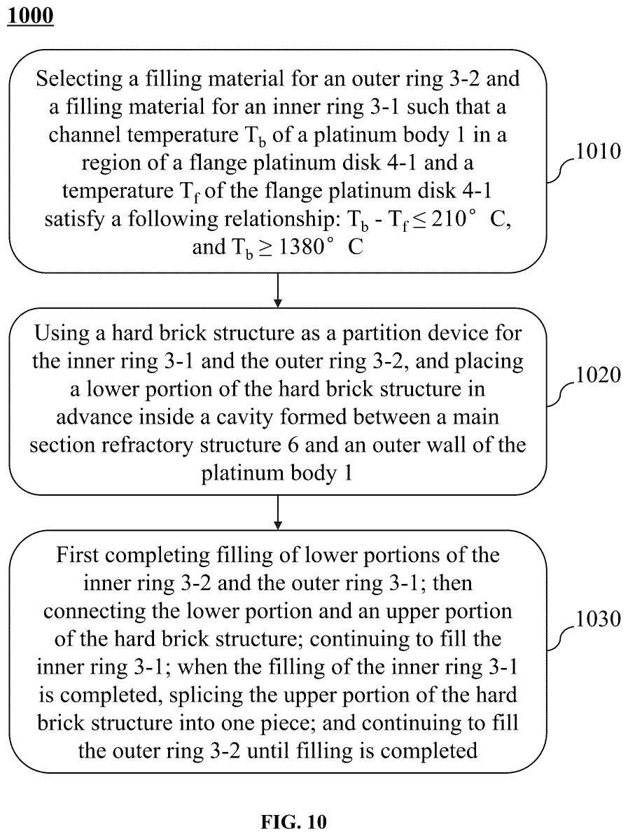

Some embodiments of the present disclosure also provide a filling method for reducing needle defects in substrate glass. The filling method for reducing needle defects in substrate glass is implemented based on the filling structure for reducing needle defects in substrate glass. The one or more filler layers 3 in the filling structure for reducing needle defects in substrate glass may form a concentric-ring structure and a segmented structure. The partition device in the filling structure for reducing needle defects in substrate glass may include a soft ceramic fiber cloth and a hard brick structure. When the structure of the one or more filler layers 3 is different, or when the partition device is different, the adopted filling method for reducing needle defects in substrate glass may be different. If the one or more filler layers form the concentric-ring structure and the partition device is the soft ceramic fiber cloth, the filling method for reducing needle defects in substrate glass may refer to related content in FIG. 9. If the one or more filler layers form the concentric-ring structure and the partition device is the hard brick structure, or if the one or more filler layers form the segmented structure, the filling method for reducing needle defects in substrate glass may refer to related descriptions in FIG. 10.

FIG. 9 is a flowchart of an exemplary process for a filling method for reducing needle defects in substrate glass according to some embodiments of the present disclosure.

In some embodiments, as shown in FIG. 9, a process 900 may include operations 910-930.

In 910, a filling material for the outer ring 3-2 and a filling material for the inner ring 3-1 may be selected such that the channel temperature T_{b} of the platinum body 1 in the region of the flange platinum disk 4-1 and the temperature T_{f} of the flange platinum disk 4-1 satisfy a following relationship: T_{b}-T_{f}≤210° C., and T_{b}≥1380° C.

In some embodiments, the filling material for the inner ring 3-1 may be selected from a material with a high thermal conductivity and high refractoriness, e.g., zirconium powder, chromium powder, magnesium powder, etc.

In some embodiments, the filling material for the outer ring 3-2 may be selected from materials with a low thermal conductivity and low heat capacity, e.g., alumina hollow spheres, aluminum silicate fibers, glass fiber cotton, etc.

In some embodiments, the filling material for the inner ring 3-1 may be zirconium powder, and the filling material for the outer ring 3-2 may be a material having a thermal conductivity of less than 1.0 W/(m·° C.).

It should be understood that the zirconium powder is a high thermal conductivity material. The zirconium powder can efficiently transfer heat from a furnace chamber to the platinum body 1. The material having a thermal conductivity of less than 1.0 W/(m·° C.) may be selected as the filling material for the outer ring 3-2 to block heat within the outer ring 3-2, thereby inhibiting platinum volatilization and crystallization.

In some embodiments, the material having a thermal conductivity of less than 1.0 W/(m·° C.) may be alumina hollow sphere powder.

In some embodiments of the present disclosure, selecting the alumina hollow sphere powder as the filling material for the outer ring 3-2 ensures a thermal insulation efficacy. Furthermore, the alumina hollow sphere powder, resistant to high temperatures, can be used for a long time, thereby reducing costs.

In some embodiments of the present disclosure, selecting the zirconium powder as the filling material for the inner ring 3-1 and selecting the material having a thermal conductivity of less than 1.0 W/(m·° C.) as the filling material for the outer ring 3-2 improves the thermal insulation efficacy, reduces an additional heating power, and lowers energy consumption.

The channel temperature T_{b} of the platinum body 1 in the region of the flange platinum disk 4-1 refers to an internal temperature of a region of the platinum body 1 connected to the flange platinum disk 4-1.

It should be noted that when other materials are used to fill the outer ring 3-2, an average thermal conductivity of the other materials needs to be below 1.0 W/(m·° C.) to meet a control requirement that a difference between the channel temperature T_{b} of the platinum body 1 in the region of the flange platinum disk 4-1 and the temperature T_{f} of the flange platinum disk 4-1 is less than or equal to 210° C., and to meet a target requirement that T_{b} reaches 1380° C. or above.

It should be noted that if the channel temperature T_{b} of the platinum body 1 in the region of the flange platinum disk 4-1 is less than 1380° C., saturated vapor pressures of Pt and Rh in a glass liquid within the platinum body 1 drop sharply. Volatilized metal vapor immediately becomes supersaturated in a cold zone of an inner wall of the platinum body 1, thereby precipitating needle-like crystals. At a same axial position, when a temperature difference between a pipe wall and the flange platinum disk 4-1 is greater than 210° C., a local cold surface at a root of the flange platinum disk 4-1 becomes a “condensation nucleus”. Needle-like crystals first form on an inner side of the flange platinum disk 4-1 and are subsequently carried by a gas flow into the glass liquid to form needle defects 2.

In 920, a soft ceramic fiber cloth may be used as a partition device for the inner ring 3-1 and the outer ring 3-2 and may be placed in advance inside a cavity portion formed between the main section refractory structure 6 and the outer wall of the platinum body 1, and two ends of the soft ceramic fiber cloth may be fixed using a clamping device.

In some embodiments, the soft ceramic fiber cloth may be placed from a top opening of the main section refractory structure 6. The soft ceramic fiber cloth utilizes its own resilience to tightly adhere to the outer wall 4-2 of the flange platinum disk. The soft ceramic fiber cloth is lifted upward along the outer wall 4-2 of the flange platinum disk towards the top opening of the main section refractory structure 6 to form a near-cylinder.

For example, a technician may first wind the soft ceramic fiber cloth around a PVC tube or a wooden mold slightly smaller than the outer wall of the platinum body 1 and secure the soft ceramic fiber cloth with a rubber band. The soft ceramic fiber cloth is resilient and maintains a C-shaped opening after release. An inner diameter of the C-shaped opening is less than or equal to a diameter of the outer wall 4-2 of the flange platinum disk. The technician may lower the soft ceramic fiber cloth with the C-shaped opening from the top opening of the main section refractory structure 6. During lowering, the C-shaped opening faces upward. When one end of the C-shaped opening passes a bottom of the outer wall 4-2 of the flange platinum disk, the soft ceramic fiber cloth automatically rebounds and opens. Then, the soft ceramic fiber cloth is lifted upward so that the soft ceramic fiber cloth may tightly adhere to and wrap around the outer wall 4-2 of the flange platinum disk to form the near-cylinder.

In some embodiments, the technician may fix the two ends of the soft ceramic fiber cloth to a top of the inner wall of the main section refractory structure 6 using the clamping device.

It should be noted that a region where the flange 4 connects to the platinum body 1 is not a completely open structure in four directions in an actual structure. Furthermore, the filling process itself involves high-temperature operations, with limited effective operation time and space. Therefore, direct operations cannot achieve an internal annular structure or an approximate annular structure as shown in FIG. 5. Thus, a simple and easily installable temporary partition structure needs to be adopted.

In 930, the outer ring 3-2 and the inner ring 3-1 may be filled, respectively, when filling of the inner ring 3-1 is completed, the clamping device is removed, the two ends of the soft ceramic fiber cloth may be spliced into one piece, and the outer ring 3-2 is continued to be filled until the filling is completed.

In some embodiments, after the two ends of the soft ceramic fiber cloth are fixed, a region below the top opening of the main section refractory structure 6 is only a semicircular region formed by the soft ceramic fiber cloth. Filling a filling material into the top opening of the main section refractory structure 6 at this time is equivalent to filling the filling material into the inner ring 3-1.

In some embodiments, after the two ends of the soft ceramic fiber cloth are joined and sealed, the region below the top opening of the main section refractory structure 6 is only an annular region formed between an outside of the soft ceramic fiber cloth and the main section refractory structure 6. Filling a filling material into the top opening of the main section refractory structure 6 at this time is equivalent to filling the filling material into the outer ring 3-2.

In some embodiments, the technician may splice the two ends of the soft ceramic fiber cloth into one piece in a plurality of manners.

For example, in response to determining that the filling of the inner ring 3-1 is completed, the technician may remove the clamping device from the two ends of the soft ceramic fiber cloth and attach a high-temperature tape to the two ends of the soft ceramic fiber cloth. The two ends of the soft ceramic fiber cloth may be spliced into one piece by the high-temperature tape.

In some embodiments, in response to determining that the filling material is filled to a preset height, the technician may insert a probe rod into the one or more filler layers 3 multiple times, obtain a depth of the probe rod each time it is inserted into the one or more filler layers 3, determine a depth difference between any two depths, and, in response to determining that the depth difference is less than or equal to a preset difference, determine that filling of this portion of the one or more filler layers 3 is completed. The probe rod refers to a component configured to probe a filling depth of the one or more filler layers 3. For example, the probe rod may be a stainless steel straight rod, a probe rod with a limit ring, etc. The depth refers to a length by which the probe rod is immersed in the filling material. The preset difference refers to a parameter for determining completion of filling of the one or more filler layers 3. In some embodiments, the preset difference may be preset by the technician based on experience.

In some embodiments of the present disclosure, selecting the soft ceramic fiber cloth as the partition device and separately filling the inner ring and the outer ring enables rapid completion of the concentric-ring division of the one or more filler layers. Furthermore, after splicing, mixing of the filling materials for the inner ring and the outer ring is prevented, allowing the filling to be completed correctly in one step, shortening maintenance time. Additionally, the soft ceramic fiber cloth can elastically absorb thermal expansion differences, extending an overhaul cycle.

FIG. 10 is a flowchart of an exemplary process for a filling method for reducing needle defects in substrate glass according to another embodiment of the present disclosure.

In some embodiments, as shown in FIG. 10, a process 1000 may include operations 1010-1030.

In 1010, a filling material for the outer ring 3-2 and a filling material for the inner ring 3-1 may be selected such that the channel temperature T_{b} of the platinum body 1 in the region of the flange platinum disk 4-1 and the temperature T_{f} of the flange platinum disk 4-1 satisfy a following relationship: T_{b}-T_{f}≤210° C., and T_{b}≥1380° C.

In 1020, a hard brick structure may be used as a partition device for the inner ring 3-1 and the outer ring 3-2, and a lower portion of the hard brick structure may be placed in advance inside a cavity portion formed between the main section refractory structure 6 and the outer wall of the platinum body 1.

In some embodiments, the technician may place the hard brick structure along the outer wall 4-2 of the flange platinum disk into the one or more filler layers 3, such that an inner wall of the hard brick structure tightly adheres to the outer wall 4-2 of the flange platinum disk.

In 1030, filling of lower portions of the inner ring 3-1 and the outer ring 3-2 may be first completed, then, the lower portion and an upper portion of the hard brick structure may be connected, the inner ring 3-1 may be continued to be filled, when the filling of the inner ring 3-1 is completed, the upper portion of the hard brick structure may be spliced into one piece, and the outer ring 3-2 may be continued to be filled until filling is completed.

In some embodiments, the technician may connect the lower portion of the hard brick structure to the upper portion thereof via a detachable structure.

In some embodiments, the technician may splice the upper portion of the hard brick structure into one piece via a spliced structure.

In some embodiments of the present disclosure, selecting the hard brick structure as the partition device and separately filling the inner ring and the outer ring enables rapid completion of the concentric-ring division of the one or more filler layers. Furthermore, the structure has its own locking components, eliminating the need for high-temperature tape for fixation, which can shorten overhaul and material replacement time. After splicing, mixing of the filling materials of the inner ring and the outer ring is prevented. Additionally, the hard brick structure can absorb thermal expansion differences, extending an overhaul cycle.

In some embodiments, when the one or more filler layers 3 form a segmented structure, filling materials for the first filler layer 3-3, the second filler layer 3-4, and the third filler layer 3-5 may be selected such that the channel temperature T_{b} of the platinum body 1 in the region of the flange platinum disk 4-1 and the temperature T_{f} of the flange platinum disk 4-1 satisfy the following relationship: T_{b}-T_{f}≤210° C., and T_{b}≥1380° C. The third filler layer 3-5, the second filler layer 3-4, and the first filler layer 3-3 are filled sequentially.

In some embodiments, a filling material for the second filler layer 3-4 may be selected from materials with a high thermal conductivity and high refractoriness, e.g., zirconium powder, chromium powder, magnesium powder, etc.

In some embodiments, the filling materials for the first filler layer 3-3 and the third filler layer 3-5 may be selected from materials with a low thermal conductivity and low heat capacity, e.g., alumina hollow spheres, aluminum silicate fibers, glass fiber cotton, etc.

In some embodiments, the second filler layer 3-4 uses zirconium powder, and both the first filler layer 3-3 and the third filler layer 3-5 use a material having an average thermal conductivity of less than 0.6 W/(m·° C.).

In some embodiments, the material having an average thermal conductivity of less than 0.6 W/(m·° C.) includes: glass fiber cotton having a thermal conductivity of 0.28 W/(m·° C.) and alumina hollow sphere powder having a thermal conductivity of 0.86 W/(m·° C.), where a volume ratio of the glass fiber cotton to the alumina hollow sphere powder is 2:1.

In some embodiments, the glass fiber cotton is a sheet material with a width of 10 mm, a length of 30 mm, and a thickness of 5 mm.

In some embodiments of the present disclosure, using the glass fiber cotton and alumina hollow sphere powder as the filling materials may reduce the mass of the filling materials, lightens the load borne by the main section refractory structure. Furthermore, the sheet-like glass fiber cotton can be laid in staggered layers, improving thermal insulation efficacy.

In some embodiments of the present disclosure, using the zirconium powder for the second filler layer and using the material having an average thermal conductivity of less than 0.6 W/(m·° C.) for both the first filler layer and the third filler layer satisfies the temperature relationship between the channel temperature T_{b} of the platinum body 1 in the region of the flange platinum disk and the temperature T_{f} of the flange platinum disk, reducing the probability of needle-like crystal precipitation.

In some embodiments of the present disclosure, sequentially filling the third filler layer, the second filler layer, and the first filler layer allows a bottom of the structure to block heat first, a middle section of the structure to supply heat rapidly, and a top of the structure to lock heat again, thereby better trapping heat inside the flange platinum disk, reducing a heat loss, lowering the probability of needle-like crystal precipitation, and reducing energy consumption.

It should be noted that when the one or more filler layers 3 form the segmented structure and the second filler layer 3-4 is filled with the zirconium powder, based on the distance and thickness estimations, the average thermal conductivity of the first filler layer 3-3 and the third filler layer 3-5 needs to be below 0.6 W/(m·° C.) to meet the target requirements of T_{b}-T_{f}≤210° C. and T_{b}≥1380° C. The embodiments of the present disclosure, considering operability, sacrifice some insulation efficiency. Therefore, for the first filler layer 3-3 and the third filler layer 3-5, a novel mixed filler using two materials is considered, namely the glass fiber cotton with a thermal conductivity of about 0.28 W/(m·° C.) and the alumina hollow sphere powder with a thermal conductivity of about 0.86 W/(m·° C.). Specific operations are as follows. A finished glass fiber cotton is processed using a cutting tool into sheet materials with a width of about 10 mm, a length of about 30 mm, and a thickness of about 5 mm. The sheet materials are mixed uniformly with the alumina hollow spheres at a volume ratio of 2:1. The resulting mixed material possesses excellent thermal insulation properties and better high-temperature resistance than the insulation cotton alone. Actual use verification shows that T_{b} reaches 1392° C., and the actual difference between T_{b} and T_{f} is 206° C., which meets the design expectations. The quantity and size of this type of defects in the product are also reduced by about 58%, with good effect.

The above content is merely for illustrating the technical concept of the embodiments of the present disclosure, and should not be used to limit the protection scope of the embodiments of the present disclosure. Any modifications made to the technical solutions based on the technical concept proposed in the embodiments of the present disclosure fall within the protection scope of the claims of the embodiments of the present disclosure.

Finally, it should be noted that: the foregoing embodiments are merely used for illustrating the technical solutions of the present disclosure, rather than limiting them. Although the present disclosure is described in detail with reference to the foregoing embodiments, those skilled in the art should understand that they may still make modifications to the technical solutions described in the foregoing embodiments or make equivalent replacements to some or all technical features therein. Such modifications or replacements do not make the essence of corresponding technical solutions depart from the scope of the technical solutions of the embodiments of the present disclosure.

What is claimed is:

1. A filling structure for reducing needle defects in substrate glass, comprising: a platinum body, a flange, and a main section refractory structure; wherein the flange is sleeved on the platinum body, the main section refractory structure is disposed outside the platinum body, and one or more filler layers are disposed in a cavity formed between the main section refractory structure and an outer wall of the platinum body; and the one or more filler layers form a concentric-ring structure or a segmented structure;
the concentric-ring structure includes an inner ring and an outer ring, wherein a partition device is disposed at a junction between the inner ring and the outer ring; a filler layer of the inner ring is a cavity portion between the outer wall of the platinum body and an outer wall of a flange platinum disk, and a filler layer of the outer ring is a cavity portion between the outer wall of the flange platinum disk and the main section refractory structure;
the segmented structure includes a first filler layer, a second filler layer, and a third filler layer arranged from top to bottom; wherein the first filler layer is a cavity portion between a first horizontal cross-section of the flange platinum disk and the main section refractory structure above the flange platinum disk, the third filler layer is a cavity portion between a second horizontal cross-section of the flange platinum disk and the main section refractory structure below the flange platinum disk, and the second filler layer is a cavity portion between the first horizontal cross-section of the flange platinum disk and the second horizontal cross-section of the flange platinum disk,
wherein the first horizontal cross-section of the flange platinum disk is disposed 80-150 mm above a top horizontal cross-section of the platinum body; and the second horizontal cross-section of the flange platinum disk is disposed 80-150 mm below a bottom horizontal cross-section of the platinum body.

2. The filling structure according to claim 1, further comprising a plurality of heating elements, wherein the plurality of heating elements are disposed on the flange platinum disk and are configured to heat the outer wall of the platinum body.

3. The filling structure according to claim 1, wherein when the one or more filler layers form the concentric-ring structure, the partition device is one of a soft ceramic fiber cloth and a hard brick structure; two ends of the soft ceramic fiber cloth are splicing ends; a material of the hard brick structure is a zirconium-based material, an upper portion of the hard brick structure has a spliced structure, and a connection between a lower portion and the upper portion of the hard brick structure is a detachable structure.

4. A filling method for reducing needle defects in substrate glass based on the filling structure for reducing needle defects in substrate glass according to claim 1, comprising:
when the one or more filler layers form the concentric-ring structure,
selecting a filling material for the outer ring and a filling material for the inner ring such that a channel temperature T_{b} of the platinum body in a region of the flange platinum disk and a temperature T_{f} of the flange platinum disk satisfy a following relationship: T_{b}-T_{f}≤210° C., and T_{b}≥1380° C.;
using a soft ceramic fiber cloth as the partition device for the inner ring and the outer ring, placing the soft ceramic fiber cloth in advance inside the cavity formed between the main section refractory structure and the outer wall of the platinum body, and fixing two ends of the soft ceramic fiber cloth using a clamping device; and
filling the outer ring and the inner ring, respectively, wherein when filling of the inner ring is completed, removing the clamping device, splicing the two ends of the soft ceramic fiber cloth into one piece, and continuing to fill the outer ring until the filling is completed.

5. A filling method for reducing needle defects in substrate glass based on the filling structure for reducing needle defects in substrate glass according to claim 1, comprising:
when the one or more filler layers form the concentric-ring structure,
selecting a filling material for the outer ring and a filling material for the inner ring such that a channel temperature T_{b} of the platinum body in a region of the flange platinum disk and a temperature T_{f} of the flange platinum disk satisfy a following relationship: T_{b}-T_{f}≤210° C., and T_{b}≥1380° C.;
using a hard brick structure as the partition device for the inner ring and the outer ring, wherein an upper portion of the hard brick structure has a spliced structure, a connection between a lower portion and the upper portion of the hard brick structure is a detachable structure,
placing the lower portion of the hard brick structure in advance inside the cavity formed between the main section refractory structure and the outer wall of the platinum body; and
first completing filling of lower portions of the inner ring and the outer ring; then connecting the lower portion and the upper portion of the hard brick structure; continuing to fill the inner ring; when the filling of the inner ring is completed, splicing the upper portion of the hard brick structure into one piece; and continuing to fill the outer ring until filling is completed.

6. The filling method according to claim 4, wherein the filling material for the inner ring is zirconium powder, and the filling material for the outer ring is a material having a thermal conductivity of less than 1.0 W/(m·° C.).

7. The filling method according to claim 6, wherein the material having a thermal conductivity of less than 1.0 W/(m·° C.) is alumina hollow sphere powder.

8. A filling method for reducing needle defects in substrate glass based on the filling structure for reducing needle defects in substrate glass according to claim 1, comprising:
when the one or more filler layers form the segmented structure,
selecting filling materials for the first filler layer, the second filler layer, and the third filler layer such that a channel temperature T_{b} of the platinum body in a region of the flange platinum disk and a temperature T_{f} of the flange platinum disk satisfy a following relationship: T_{b}-T_{f}≤210° C., and T_{b}≥1380° C.; and
filling the third filler layer, the second filler layer, and the first filler layer sequentially.

9. The filling method according to claim 8, wherein the second filler layer uses zirconium powder, and both the first filler layer and the third filler layer use a material having an average thermal conductivity of less than 0.6 W/(m·° C.).

10. The filling method according to claim 9, wherein the material having an average thermal conductivity of less than 0.6 W/(m·° C.) includes glass fiber cotton having a thermal conductivity of 0.28 W/(m·° C.) and alumina hollow sphere powder having a thermal conductivity of 0.86 W/(m·° C.), wherein a volume ratio of the glass fiber cotton to the alumina hollow sphere powder is 2:1; and the glass fiber cotton is a sheet material having a width of 10 mm, a length of 30 mm, and a thickness of 5 mm.
